(19) United States
(12) Patent Application Publication
(10) Pub. No.: US 2025/0228394 A1
(43) Pub. Date: Jul. 17, 2025

(54) HEATING DEVICE FOR A MACHINE FOR PREPARING HOT BEVERAGES

(71) Applicant: I.R.C.A. S.P.A INDUSTRIA RESISTENZE CORAZZATE E AFFINI, Vittorio Veneto (IT)

(72) Inventors: Christian BORTOLUZZI, Godega di Sant’'Urbano (IT); Daniele DE LUCA, Vittorio Veneto (IT); Stefano WEDAM, Mareno di Piave (IT); Federico ZOPPAS, Treviso (IT)

(21) Appl. No.: 18/875,392

(22) PCT Filed: Jun. 12, 2023
(86) PCT No.: PCT/IB2023/056038

§ 371 Date: Dec. 16, 2024

(30) Foreign Application Priority Data
Jun. 23, 2022 (IT) 102022000013258

(51) Int. Cl. A47J 31/54; F24H 1/16

(52) U.S. Cl. CPC A47J 31/542; F24H 1/162; F24H 2250/02

(57) ABSTRACT

A heating device (1), in particular a flow through heater, for a machine for preparing hot beverages,
the heating device (1) comprising
   a metal body (2) made of aluminum or aluminum alloy;
   at least one electric heater (3) arranged in the metal body (2);
   a conduit (4) for the passage of an edible liquid to be heated, in particular water, delimited by a first inner surface (21) of the metal body (2);
wherein the metal body (2) comprises a first end portion (24a) and a second end portion (24b) which delimit an initial stretch and a final stretch, respectively, of said conduit (4);
wherein the first end portion (24a) and the second end portion (24b) have a respective outer surface (241a, 241b) and are adapted to be inserted into a respective tube (9);
wherein said first inner surface (21), the outer surface (241a) of said first end portion (24a) and the outer surface (241b) of said second end portion (24b) are coated with a respective coating layer, in particular suitable for food contact.

### FIELD OF THE INVENTION

The present invention relates to the field of devices for preparing beverages, in particular for domestic use.

In particular, the invention relates to a heating device, more in particular an instantaneous exchanger or heater or flow through heater, adapted to heat a flow of liquid, in particular water, for preparing the beverage.

### BACKGROUND ART

Machines for preparing hot beverages, such as coffee, are very common.

Such machines are provided with a heating device adapted to heat water for preparing the beverage.

One type of heating device is referred to as a flow through heater (FTH), or flow heater or instant heater, in particular instant flow heater. A flow through heater is particularly adapted to heat a water flow, i.e., adapted to heat water as it flows in a conduit of the device.

Heating devices of the FTH type comprise a metal body, a conduit for the liquid to be heated and one or more heating elements which generate heat by Joule effect. It is desirable to make the metal body of aluminum or aluminum alloy, as it is a material which conducts heat well.

However, the aluminum metal body should not come into direct contact with the liquid to be heated, due to health concerns.

Therefore, the heating devices involve the insertion of a stainless steel tube into the metal body, so that the liquid comes into contact with the stainless steel tube and not with the metal body. The steel tube is typically brazed to the metal body.

However, the use of steel tubes has several disadvantages, including: reduced energy efficiency; adhesion of limestone to the steel tube; greater device production complexity and longer construction times.

Furthermore, the steel tube does not provide any electrical insulation between the liquid and the heating element.

Therefore, the need is felt to overcome the limitations of the prior art.

### SUMMARY OF THE INVENTION

It is an object of the present invention to provide a heating device, in particular of the FTH type, for machines for preparing beverages which is particularly safe for health.

Another object of the invention is to make a heater of the FTH type which is safe for health and energy efficient.

Another object of the invention is to make a heater of the FTH type which is safe for health and can be produced easily.

The present invention achieves at least one of such objects, and other objects which will become apparent in the light of the present description, by means of a heating device, in particular a flow through heater, for machine for preparing hot beverages, the heating device comprising
a metal body, made of aluminum or aluminum alloy;
at least one electric heater arranged in the metal body;
a conduit for the passage of an edible liquid to be heated, in particular water, delimited by a first inner surface of the metal body;
   in which the metal body comprises a first end portion and a second end portion which delimit an initial stretch and a final stretch, respectively, of said conduit;
   in which the first end portion and the second end portion have a respective outer surface and are adapted to be inserted into a respective tube;
   in which said first inner surface, the outer surface of said first end portion and the outer surface of said second end portion are coated with a respective coating layer, in particular suitable for food contact.

The invention further relates to a machine for preparing beverages, according to claim 12.

Advantageously, a device according to the invention allows for the use of a metal body made of aluminum or aluminum alloy which delimits the conduit for the passage of liquid, and maximizes food safety, i.e., safety for people's health. In fact, the coating layer prevents direct contact between the liquid and aluminum or aluminum alloy.

In particular, advantageously, the coating layer of said first inner surface prevents the contact of the metal of the metal body with the liquid flowing inside the conduit. Furthermore, it is particularly advantageous that the outer surface of said first end portion and the outer surface of said second end portion are also provided with a respective coating layer. In fact, when said end portions are inserted into a respective tube, liquid can fill the gap between the outer surface of each end portion and the respective tube. Therefore, the coating layer prevents direct contact with the aluminum or aluminum alloy in such areas as well.

In particular, each coating layer is made of polymer material or sol-gel.

Preferably, each coating layer is made of, or substantially made of the following materials: a Polyamide (PA), Polytetrafluoroethylene (PTFE), Perfluoroalkoxy (PFA), Fluorinated Ethylene Propylene (FEP), a Polyurethane (PU), a polyester, an epoxy material, a silicone, a sol-gel, amorphous silicon, amorphous silicon oxide, silicon nitride, silicon dioxide, polysilicon, fluorocarbon, organofluorine.

It is particularly preferred that each coating layer is made of, or substantially made of Polyamide (PA).

In particular, Polyamide makes the production process of the device easy and fast, as well as being suitable for food contact. In particular Polyamide allows making said device easily and quickly, without the need to pre-treat the surface to be coated, and allows bending the conduit after the coating operation, thus avoiding the coating layer from being damaged.

The following materials are particularly advantageous because they are suitable for coating hard-to-reach surfaces: amorphous silicon, amorphous silicon oxide, silicon nitride, silicon dioxide, polysilicon, fluorocarbon, organofluorine.

Advantageously, the coating layers allow increasing resistance to limestone adhesion.

Further features and advantages of the invention will become more apparent in the light of the detailed description of exemplary, but non-exclusive embodiments thereof.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a perspective view of a device according to the invention;

FIG. 1A diagrammatically shows a sectional view of a detail of the device of FIG. 1, with an end portion of the device inserted into a tube;

FIG. 2 shows section A-A of FIG. 1;

FIG. 3 shows section A-A only of the metal body of the device of FIG. 1;

FIG. 4 shows another perspective view of the device of FIG. 1;

FIG. 5 shows a plan view of the device of FIG. 1.

The same elements or components have the same reference numerals.

### DESCRIPTION OF EMBODIMENTS OF THE INVENTION

With reference to the Figures, non-limiting exemplary embodiments of a device 1, or heating device, for a machine for preparing hot beverages, according to the invention are described.

In particular, the device 1 is of the flow through heater type, or instant heater or flow heater type.

In particular, the device 1 is adapted to be mounted in the machine for preparing hot beverages. By way of example and not by way of limitation, the machine is for preparing coffee.

In all the embodiments, the device 1 comprises
a metal body 2 made of aluminum or aluminum alloy;
at least one electric heater 3 arranged in the metal body 2;
a conduit 4 for the passage of an edible liquid to be heated, in particular water, delimited by a first inner surface 21 of the metal body 2;
   in which the metal body 2 comprises a first end portion 24a and a second end portion 24b which delimit an initial stretch and a final stretch, respectively, of said conduit 4;
   in which the first end portion 24a and the second end portion 24b have a respective outer surface 241a, 241b and are adapted to be inserted into a respective tube 9;
   in which said first inner surface 21, the outer surface 241a of said first end portion 24a and the outer surface 241b of said second end portion 24b are coated with a respective coating layer, in particular suitable for food contact.

The device 1 is particularly adapted to heat a water flow, more in particular it is adapted to heat water as it flows in the conduit 4 of the device 1.

The coating layers are in particular adapted to contact the edible liquid to be heated (or heated by the device 1, in the case of the coating layer of the end portion 24b), in particular they are adapted to be wetted by the edible liquid to be heated (or heated by the device 1, in the case of the coating layer of the end portion 24b).

In particular, the coating layers are made of a different material with respect to the metal body 2.

The coating layers are preferably made of the same material.

The coating layers preferably have the same thickness.

Each coating layer is preferably made of a polymer material or sol-gel.

Preferably, each coating layer is substantially made of, or made of one of the following materials: a Polyamide (PA), Polytetrafluoroethylene (PTFE), Perfluoroalkoxy (PFA), Fluorinated Ethylene Propylene (FEP), a Polyurethane (PU), a polyester, an epoxy material, a silicone, a sol-gel, amorphous silicon, amorphous silicon oxide, silicon nitride, silicon dioxide, polysilicon, fluorocarbon, organofluorine.

It is particularly preferred that each coating layer is substantially made of, or made of Polyamide (PA).

Polyamide has been carefully selected. Indeed, the Inventors have found that Polyamide offers various advantages.

In particular, Polyamide allows facilitating the production process of the device 1. In fact, Polyamide does not require pre-treatment operations of the surfaces to be coated. In particular, Polyamide does not require mechanical operations on the surface to be coated, such as abrasion of the surface to be coated to increase the roughness thereof.

Polyamide further has suitable mechanical properties such that, to obtain a conduit 4 with one or more curved sections, the inner surface of a metal body 2 the conduit 4 of which is straight can first be coated with polyamide; then the metal body 2 can be bent so that the conduit 4 has one or more curved sections. In particular, by bending the inner surface 21 (coated with polyamide) delimiting the conduit 4, the Polyamide coating layer is not damaged. The same applies in the case of obtaining curved end portions of 24a, 24b.

Furthermore, advantageously, Polyamide allows coating a conduit 4 having an inner diameter from 2 to 10 mm, for example from 4 to 7 mm. In other words, Polyamide advantageously allows coating a conduit 4 having a very small inner diameter.

The following materials are particularly advantageous because they are suitable for coating hard-to-reach surfaces: amorphous silicon, amorphous silicon oxide, silicon nitride, silicon dioxide, polysilicon, fluorocarbon, organofluorine.

In particular, the coating layer is made of a material approved for food contact.

“Approved for food contact” preferably means approved by one or more entities, preferably by the FDA (Food and Drug Administration) and/or by the BfR (Bundesinstitut für Risikobewertung) and/or others.

The coating layer preferably also has non-stick properties, in particular with respect to limestone.

Preferably, each coating layer has a thickness from 2 to 100 μm; preferably from 5 to 25 μm.

Preferably, substantially the entire inner surface 21 is provided with the respective coating layer; substantially the entire outer surface 241a is provided with the respective coating layer; and substantially the entire outer surface 241b is provided with the respective coating layer.

In addition to the outer surfaces 241a, 241b, other areas of the outer surface of the metal body 2 can also optionally be provided with a coating layer. For example, all or substantially all of the outer surface of the metal body 2 can be provided with a coating layer.

Said at least one electric heater 3 is, in particular, outside the channel 4, in particular completely outside the channel 4.

In particular, the metal body 2 is provided with two channels or holes, in particular through holes. One of the two holes forms said conduit 4 for the liquid. In the other hole 30 (FIG. 3) said electric heater 3 is arranged or made.

Each hole is delimited by a respective inner surface 21, 22 of the metal body 2. The metal body 2 is preferably a monolithic body, in particular obtained by extrusion. In particular, the monolithic metal body 2 comprises said two end portions 24a, 24b. Therefore, the end portions 24a, 24b are also made of aluminum or aluminum alloy. The end portions 24a, 24b are in particular tubular portions.

Part of the inner surface 21 of the conduit 4 is formed or defined by the end portion 24a, and part of the inner surface 21 of the conduit 4 is formed or defined by the end portion 24b.

The outer surface 241a of the end portion 24a and the outer surface 241b of the end portion 24b are opposite a respective portion of the inner surface 21.

The end portion 24a comprises the opening 242a or inlet section (for the liquid) of the conduit 4, and the end portion 24b comprises the opening 242b or outlet section (for the liquid) of the conduit 4.

Preferably, the end portion 24a provided with the coating layer extends (in particular, along the longitudinal axis of the conduit 4) from 2 to 150 mm, preferably from 10 to 150 mm, preferably from 25 to 50 mm, from the end delimiting the inlet opening 242a; and the end portion 24b provided with the coating layer extends (in particular, along the longitudinal axis of the conduit 4) from 2 to 150 mm, preferably from 10 to 150 mm, preferably from 25 to 50 mm, from the end delimiting the outlet opening 242b.

In particular, the inner surface 21 and the inner surface 22 extend about a respective axis, in particular they extend about a respective longitudinal axis. In particular, the inner surface 21 and the inner surface 22 are continuous surfaces extending about said respective axis. In particular, said respective axis can be straight, curved, or can comprise one or more straight sections and one or more curved sections.

Preferably, the axes about which the inner surface 21 and inner surface 22 extend are parallel to each other.

In particular, preferably, said at least one electric heater 3 and said conduit 4 extend parallel to each other.

Preferably, the length of the inner surface 21 along the axis about which it extends is greater than the length of the inner surface 22 along the axis about which it extends.

Preferably, the conduit 4 has a greater length than the length of said at least one electric heater 3.

In particular, each end portion 24a, 24b protrudes, in particular outwards, with respect to the end 30a, 30b of the at least one electric heater 3 being proximal thereto.

Advantageously, thereby, the end portions 24a, 24b can be inserted into a respective tube 9, in particular into a respective flexible tube.

However, it is possible that the end portions 24a, 24b can be inserted into a respective tube 9 in other manners.

Preferably, the electric heater 3 and the conduit 4 each comprise a spirally wound section. In particular, the spirally wound section of the conduit 4 is arranged between the initial section of the conduit 4, delimited by the end portion 24a, and the final section of the conduit 4, delimited by the end portion 24b.

Preferably, the inner surface 21 and the inner surface 22 have a circular section.

Preferably, the conduit 4 has an inner diameter from 2 to 10 mm, preferably from 4 to 7 mm.

Preferably, the end portion 24a and the end portion 24b are straight or substantially straight.

The aforesaid electric heater 3 comprises at least one electric resistor 31, or resistive element or electric resistor, embedded in an electrically insulating material 32.

The electric resistor 31 is for example a resistive cable or wire, preferably spirally wound, in particular about the longitudinal axis thereof.

The electrically insulating material 32 is preferably magnesium oxide.

The electrically insulating material 32 is in contact, in particular directly in contact, with the inner surface 22 (distinct from the inner surface 21) of the metal body 2.

The electric heater 3 is adapted to generate heat by Joule effect, i.e., it is adapted to generate heat when it is crossed by an electric current.

Advantageously, the coating layer coating the inner surface 21 is adapted to ensure an electrical insulation, in particular an additional electrical insulation with respect to said electrically insulating material 32, between the electric heater 3 and the edible liquid flowing in the conduit 4.

For the power supply, two pins 33a, 33b are provided, each connected to a respective end of the electric resistor 31. The pins 33a, 33b exit from the metal body 2.

In particular, two closing elements 34a, 34b made of electrically insulating material, for example ceramic material, are further provided. The closing elements 34a, 34b are fixed to the metal body 2, and are crossed by a respective pin 33a, 33b. In particular, the closing elements 34a, 34b are inserted into the hole 30 of the metal body 2 delimited by the inner surface 22.

In all the embodiments, the electric heater 3 can transfer heat to the liquid flowing in the conduit 4, through the metal body 2.

In particular, the heat generated by the electric heater 3 is transmitted to the metal body 2, which in turn transmits it to the liquid.

More in particular, the two holes 4, 30 of the metal body 2 are separated from each other by a wall 23 of the metal body 2. Preferably, a portion of the inner surface 21 and a portion of the inner surface 22 are opposite each other and are in particular portions of said wall 23.

Optionally, the metal body 2 can also be provided with one or more further electric heaters 3, each arranged in a respective hole of the metal body 2. Therefore, the metal body 2 can be provided with more than two distinct holes or channels.

As already mentioned, the invention further relates to a machine for preparing beverages comprising a device 1.

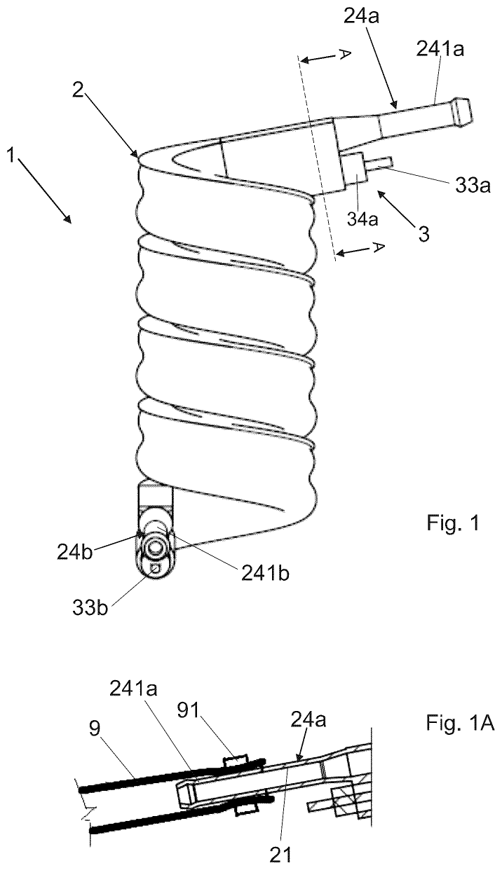

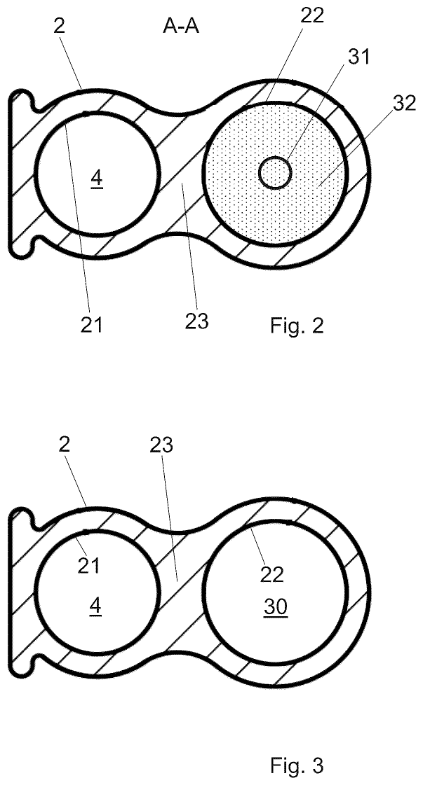

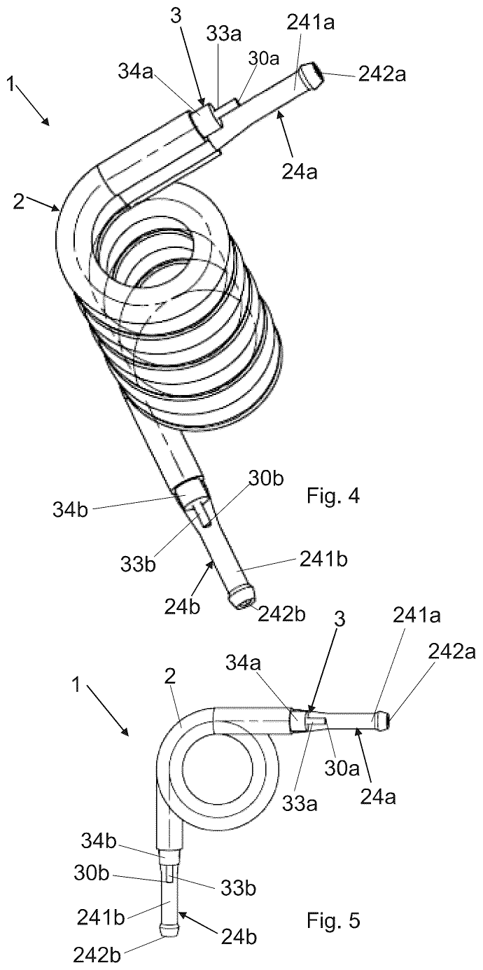

In particular, the machine can comprise two tubes 9, in particular two flexible tubes. One of the two tubes 9 is diagrammatically shown in FIG. 1A.

A first tube of said two tubes 9 is adapted to conduct the liquid to be heated in the conduit 4, and the other tube (or second tube) of the two tubes is adapted to receive the heated liquid exiting from the conduit 4.

In particular, the first end portion 24a of the metal body 2 is inserted into the first tube 9, and the second end portion 24b of the metal body 2 is inserted into the second tube.

Fixing means 91 are preferably provided for fixing, in particular in a sealing manner, each tube 9 to the respective end portion 24a, 24b.

By way of mere example and not by way of limitation, each tube 9 is fixed to the respective end portion 24a, 24b by one or more clamps 91.

A device 1 according to the invention offers several advantages, including those listed below.

With particular reference to FIG. 3, it can be noted that when an end portion 24a, 24b is inserted into the respective tube 9, the liquid can enter the gap between each end portion 24a, 24b and the respective tube into which it is inserted. Advantageously, the coating layer of the outer surfaces 241a, 241b prevents contact (in particular direct contact) between the liquid and the aluminum or aluminum alloy from which the end portions 24a, 24b are made.

The presence of the coating layer coating the inner surface 21 allows making the metal body 2 of aluminum or aluminum alloy, so as to transmit heat well, and avoiding the use of a tube, for example made of stainless steel, inside the hole delimited by the inner surface 21. In fact, since the coating layer is suitable for food contact, and is interposed between the liquid and the metal body 2 (the coating layer is wet by the liquid), it is not necessary to use the steel tube to overcome the compatibility problems related to food contact of the metal body 2 in aluminum or aluminum alloy. Therefore, the heating device 1 is safe for health.

The heat exchange efficiency between the electric heater 3 and the liquid flowing in the conduit 4 is also improved. In fact, there are no heat losses due to the presence of a steel tube where the liquid flows.

Furthermore, the coating layer allows increasing the adhesion resistance of the limestone on the wall of the conduit 4.

Advantageously, the electrical safety is further increased by placing the coating layer between the liquid and the metal body 2, as previously explained.

Advantageously, moreover, by using a coating layer having a lower electrical conductivity than the material of which the metal body 2 is made, it is possible to check, easily and quickly, and in particular compatibly with mass production, whether the coating layer has been applied correctly.

1. A heating device, in particular a flow through heater, for a machine for preparing hot beverages,
the heating device comprising
a metal body made of aluminum or aluminum alloy;
at least one electric heater arranged in the metal body;
a conduit for the passage of an edible liquid to be heated, in particular water, delimited by a first inner surface of the metal body;
wherein the metal body comprises a first end portion and a second end portion which delimit an initial stretch and a final stretch, respectively, of said conduit;
wherein the first end portion and the second end portion have a respective outer surface and are adapted to be inserted into a respective tube;
wherein said first inner surface, the outer surface of said first end portion and the outer surface of said second end portion are coated with a respective coating layer, in particular suitable for food contact.

2. The heating device according to claim 1, wherein each coating layer is made of a polymer material or sol-gel.

3. The heating device according to claim 1, wherein each coating layer is made or substantially made of one of the following materials: a Polyamide (PA), Polytetrafluoroethylene (PTFE), Perfluoroalkoxy (PFA), Fluorinated Ethylene-Propylene (FEP), a Polyurethane (PU), a polyester, an epoxy material, a silicone, or a sol-gel.

4. The heating device according to claim 1, wherein each coating layer is made or substantially made of one of the following materials: amorphous silicon, amorphous silicon oxide, silicon nitride, silicon dioxide, polysilicon, fluorocarbon, or organofluorine.

5. The heating device according to claim 1, wherein each coating layer is made or substantially made of Polyamide (PA).

6. The heating device according to claim 1, wherein each coating layer has a thickness from 2 to 100 μm; preferably from 5 to 25 μm.

7. The heating device according to claim 1, wherein the conduit has a length greater than the length of said at least one electric heater; in particular so that the first end portion and the second end portion are adapted to be inserted into the respective tube.

8. The heating device according to claim 1, wherein each end portion protrudes, in particular outwards, with respect to the end of the at least one electric heater being proximal thereto.

9. The heating device according to claim 1, wherein said at least one electric heater comprises at least one electric resistor incorporated in an electrically insulating material; wherein said electrically insulating material is in contact, in particular directly in contact, with a second inner surface of the metal body.

10. The heating device according to claim 1, wherein said at least one electric heater and said conduit extend parallel to each other.

11. The heating device according to claim 1, wherein said conduit has an inner diameter from 2 to 10 mm; preferably from 4 to 7 mm.

12. A machine for preparing beverages comprising a device according to claim 1.

13. The machine according to claim 12, comprising a first tube, in particular flexible, and a second tube, in particular flexible;
wherein said first end portion is inserted into said first tube and said second end portion is inserted into said second tube.
